(19) United States
(12) Patent Application Publication
(10) Pub. No.: US 2007/0028751 A1
(43) Pub. Date: Feb. 8, 2007

(54) System for using sound inputs to obtain video display response

(76) Inventor: David Hindman, Brooklyn, NY (US)

Correspondence Address: LANIER FORD SHAVER & PAYNE, P O BOX 2087, HUNTSVILLE, AL, 35804, US

(21) Appl. No.: 11/472,188

(22) Filed: Jun. 21, 2006

Related U.S. Application Data
(60) Provisional application No. 60/705,366, filed on Aug. 4, 2005.

(51) Int. Cl. G10H 7/00

(52) U.S. Cl. 84/645

(57) ABSTRACT

A system for manipulating a video display using at least one musical tone as control input comprises a data converter for receiving a sound signal that includes one or more musical parameters associated with the musical tones, comparing the parameters to one or more pre-specified parameters, and converting the signal into a data signal. A control command relay for converting the data signal into a command signal, and a display interface converts the command signal to a display command signal.

### CROSS REFERENCE TO RELATED APPLICATIONS

This application claims priority of U.S. provisional application Ser. No. 60/705,366, filed Aug. 4, 2005, and incorporated by reference herein.

### SUMMARY OF THE INVENTION

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein.

A system for manipulating a video display using musical tones as a control input comprises a data converter for receiving a signal that includes one or more parameters associated with the musical tone. The data converter compares the received parameters to stored parameters, and converts the signal into a command signal. A display interface converts the command signal to a display command signal.

In one embodiment the system accepts MIDI signals from MIDI capable instruments. In another embodiment, the system includes hardware and software that is adapted to convert an audio signal from an electric or acoustic instrument to a MIDI signal. It should be noted that other computer-readable code formats aside from MIDI are usable with the present invention.

In yet another embodiment, the system is configured to parse audio signals that transmit information related to parameters associated with a musical sound and compare them to such parameters that are stored in the same format.

The invention may be achieved in embodiments where musical parameters are at least one of pitch, dynamic or volume, and rhythm. In a further embodiment, the input may be not only single tones, but also a sequence of tones, for example, an arpeggio or scale, or a set of simultaneously played tones such as a chord.

These and other embodiments of the present invention will also become readily apparent to those skilled in the art from the following detailed description of the embodiments having reference to the attached figures, the invention not being limited to any particular embodiment(s) disclosed.

### BRIEF DESCRIPTION OF THE DRAWINGS

Embodiments of the present invention are described with reference to the accompanying drawings. In the drawings, like reference numbers indicate identical or functionally similar elements. Additionally, the left-most digit(s) of a reference number identifies the drawing in which the reference number first appears.

FIG. 1 is a functional diagram of one exemplary embodiment of the present invention;

FIG. 2 is a functional diagram of an exemplary signal-to-data converter according to an embodiment of the present invention;

FIG. 3 is a functional diagram of an exemplary signal-to-data converter according to another embodiment of the present invention;

FIG. 4 is a functional diagram of an exemplary display interface according to an embodiment of the present invention;

FIG. 5 is a functional diagram of an exemplary display interface according to another embodiment of the present invention;

FIG. 6A is a flow diagram of a method to determine accuracy of pitch and/or dynamic information carried by an incoming audio data signal according to one embodiment of the present invention;

FIG. 6B is a flow diagram of a method to determine accuracy of a pitch sequence of length n carried by an incoming audio data signal according to one embodiment of the present invention;

FIG. 6C is a flow diagram of a method to determine accuracy of n simultaneously received pitch parameters carried by an incoming audio data signal according to one embodiment of the present invention;

FIG. 6D is a flow diagram of a method to determine accuracy of non-note parameters carried by an incoming audio data signal according to one embodiment of the present invention; and

FIG. 6E is a flow diagram of a method to determine accuracy of a sequence of non-note parameters of length n carried by an incoming audio data signal according to one embodiment of the present invention.

### DETAILED DESCRIPTION

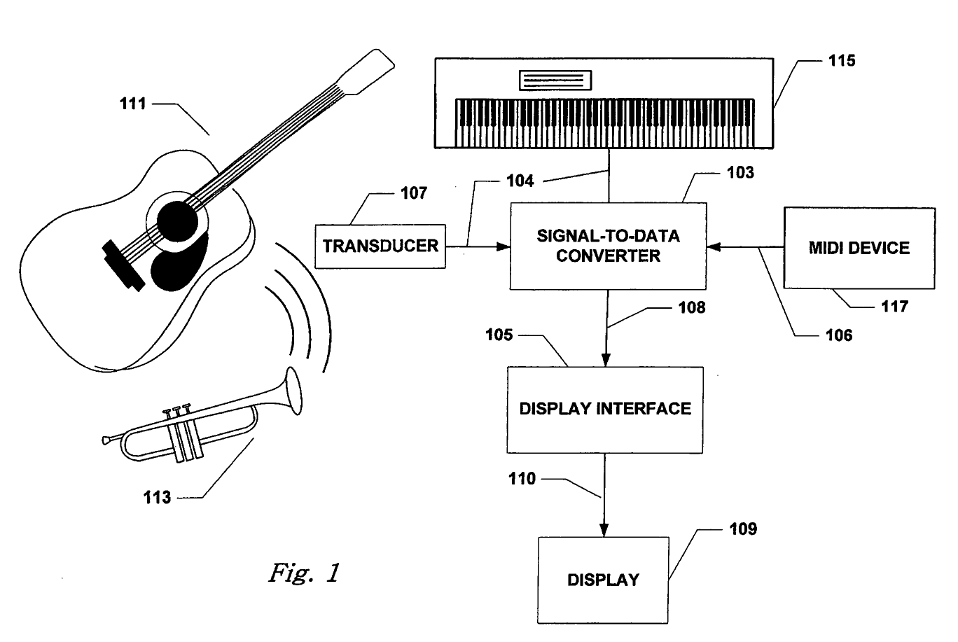

The various embodiments of the present invention and their advantages are best understood by referring to FIGS. 1 through 6E of the drawings. The elements of the drawings are not necessarily to scale, emphasis instead being placed upon clearly illustrating the principles of the invention. Throughout the drawings, like numerals are used for like and corresponding parts of the various drawings.

Furthermore, reference in the specification to “an embodiment,” “one embodiment,” “various embodiments,” or any variant thereof means that a particular feature or aspect of the invention described in conjunction with the particular embodiment is included in at least one embodiment of the present invention. Thus, the appearance of the phrases “in one embodiment,” “in another embodiment,” or variations thereof in various places throughout the specification are not necessarily all referring to its respective embodiment.

This invention may be provided in other specific forms and embodiments without departing from the essential characteristics as described herein. The embodiments described below are to be considered in all aspects as illustrative only and not restrictive in any manner. The claims issued in any ensuing non-provisional application rather than the following description indicate the scope of the invention.

The term “Musical Instrument Digital Interface,” or “MIDI,” is commonly known in the art as an industry standard communications protocol for transmitting information about music or sound production, such as, for example, frequency, length, intensity, and tone. However, as used herein, it should be understood that the term “MIDI” can be a shorthand term meaning not only the MIDI standard but also any other suitable form of encoding of music or sound information for transmission now known or hereafter developed.

FIG. 1 is a functional diagram of an exemplary system for manipulating a graphical software output with musical tones that comprises a signal-to-data converter 103 that outputs to a display interface 105 that, in turn, outputs to a display 109. Signal-to-data converter 103 receives either MIDI coded signal 106 input, or, in the alternative, audio signals 104 that represent or carry information related to musical parameters, and, compares the received information to pre-specified criteria stored in a data structure or data base. If the received parameters meet the pre-specified criteria, the signal-to-data converter 103 converts such input to a validated data signal 108. The validated data signal 108 is output to display interface 105 which receives the validated data input and is configured to convert such validated data to audio/video control signals 110. Display 109 is responsive to control signals according to control logic to provide video, and/or audio, responses.

Audio signal 104 may be generated by a musical instrument indirectly where an acoustic musical instrument 111, 113 is played to provide sound energy to transducer 107, for example, a microphone, where the sound is converted to an audio signal 104. In the alternative, audio signal 104 may be generated directly by an electric musical instrument 115, for example, an electric guitar or keyboard, or other suitable electrical instrument. MIDI coded signal 106 may be from any MIDI capable device 117.

Uses of the system include entertainment and instruction. The system may be configured with control logic to render video and audio responses only when the correct musical parameters are obtained from the instrument. The correct musical parameters could be in terms of many different music-related parameters, non-limiting examples of which include pitch, dynamic or volume, and pitch sequences, such as scales or arpeggios. For example, the system control logic could include a command for a video object shown by the video display to jump when a C Major arpeggio is rendered by the instrument. When the C Major arpeggio is correctly played by the musician, the system causes the video character to jump, providing positive reinforcement. It should be noted that the system could be configured to provide responses when the correct pitch or pitch sequence, etc., is not played, thereby providing negative reinforcement to hopefully correct errant play.

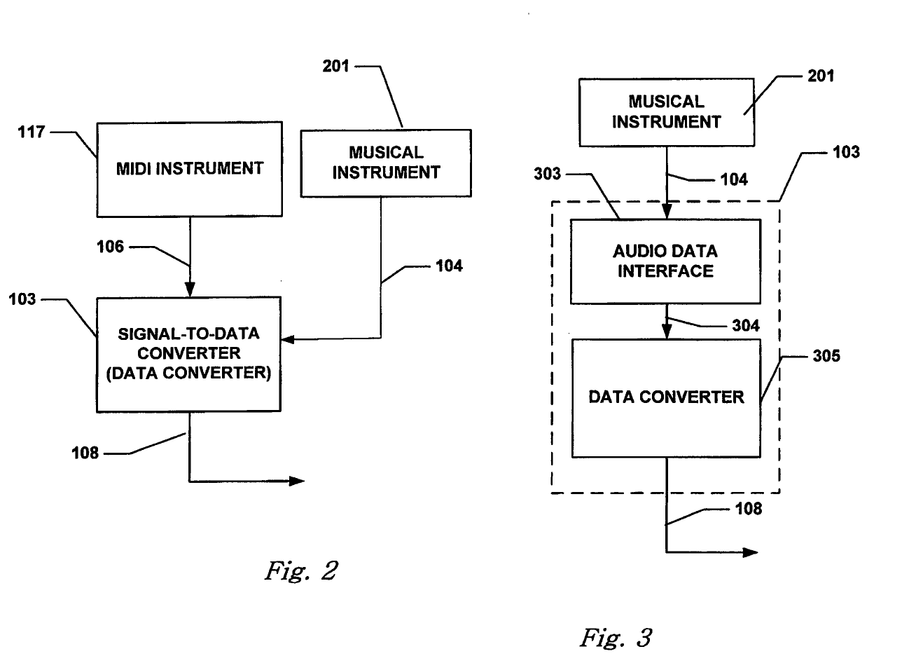

Referring now to FIG. 2, a functional diagram of one embodiment of the present invention is depicted in greater detail. In this embodiment, MIDI device 117 provides a MIDI format coded signal 106 to signal-to-data converter 103. Similarly, signal-to-data converter 103 may receive input from an acoustic or electrical musical instrument 201 that provides non-MIDI audio signal 104. Signal-to-data converter 103 may be configured with control logic to assess data received in either the coded signal 106 or the audio signal 104 to determine whether it meets pre-specified criteria. If the data meets such pre-specified criteria, the signal is converted to validated data signal 108 and is output for processing by display interface 105. In the case of the MIDI coded signal 106, for example, signal-to-data converter 103 may be configured with control logic that tests whether received MIDI codes match pre-specified codes for pitch and/or a dynamic (forte, pianissimo, etc.) musical parameter. In MIDI code, the latter parameter may be expressed in terms of velocity. To process audio signal 104, signal-to-data converter 103 may be configured with control logic to decipher parameter information from audio signal 104. For example, a Fast Fourier Transform (FFT) may be employed to provide real-time deciphering of pitch information carried by the audio signal. Further, signal-to-data converter 103 may be adapted to assess the incoming signal 104, 106 against a sequence of pitches, and combinations of pitch and dynamics, among other music or sound related parameters. Validated data signal 108 may be, for example and without limitation, in the form of the RS232 standard serial binary data interconnection, or other suitable data interconnection.

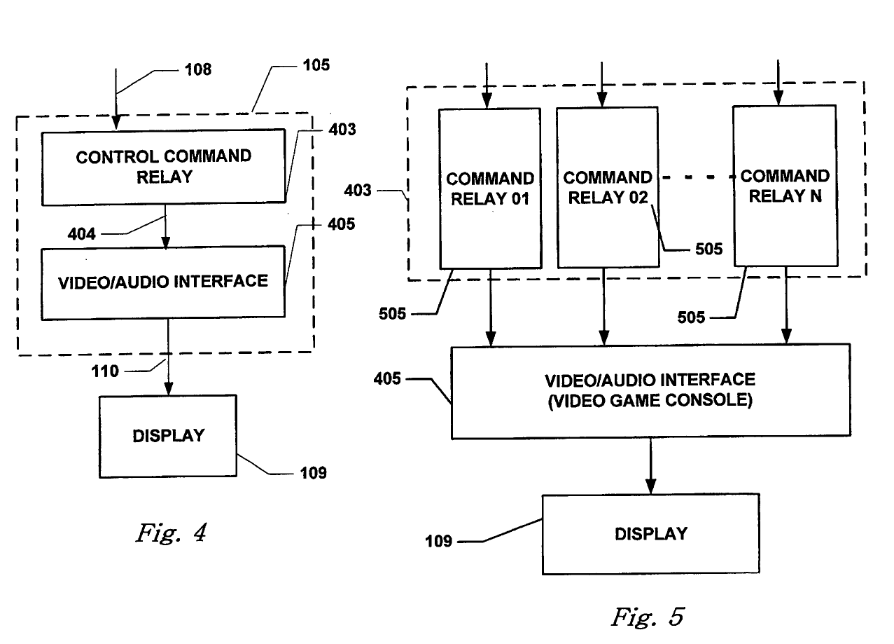

Another embodiment is described with reference to FIG. 3 wherein an acoustic or electrical musical instrument 201 provides an audio signal 104 to signal-to-data converter 103 which is comprised of, in this example, two components. Audio data interface 303 receives audio signal 104 and outputs an audio data signal 304 which is received as input to a data converter 305. Audio data interface 303 is a computer or processor system which is configured to convert audio signal 104 into an audio data signal 304 which may be a signal in MIDI standard format, or other suitable format known by those skilled in the relevant arts that is used to encode music or sound signals. Audio data signal 304 that may be provided in a variety of data communications protocols, for example, Firewire® offered by Apple Computer, Inc. (or IEEE 1394 standard), or the like.

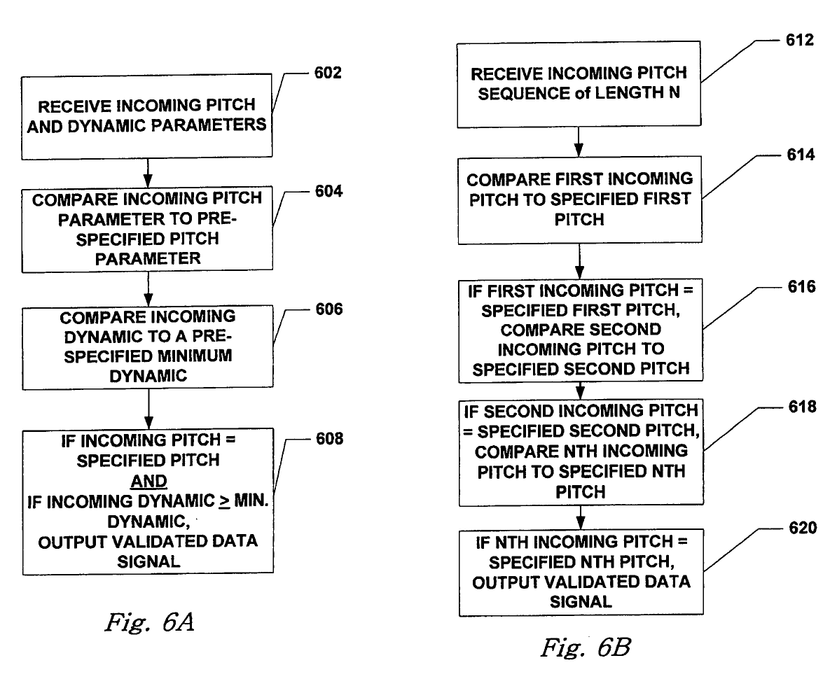

As shown in FIG. 4, validated data signal 108 is provided as input to display interface 105, which, in this exemplary embodiment, includes one or more processors that are configured with control logic to convert a received validated data signal 108 to pre-defined audio/video control signals 110 which are then output to display 109. In this embodiment, display interface 105 includes a control command relay 403 coupled to video/audio interface 405. Control command relay 403 may be one or more processors configured with control logic to receive as input validated data signal 108 from signal-to-data converter 103, and to output control command signals 404 based upon validated data signal 108. Video/audio interface 405 is responsive to control command signals 404 and may be comprised of one or more processors configured with control logic and converts control command signals 404 to audio/video signals 110 to which display 109 is responsive and which cause display 109 to respond with either the appropriate video object response or the appropriate audio response, or both, according to the corresponding musical input and the pre-specified criteria.

Operation of the embodiment adapted as described above for interaction with an acoustic instrument 111, 113 begins with a musical sound, for example, a pitch of a desired dynamic quality being played, creating sound which is converted by transducer into an audio signal 104. Audio signal 104 is received as input by signal-to-data converter 103. Control logic in the signal-to-data converter 103 determines whether the pitch and dynamic quality carried in the audio signal 104 meet the criteria for issuing a video or audio command, e.g., “jump” or “punch” or “kick.” If the pitch and dynamic quality of the audio signal 104 meet the criteria, a validated data signal 108 encoded with the appropriate command (e.g., “jump”, “punch” or “kick”) is output. Finally, display interface 105 receives validated data signal 108 and outputs the appropriate command signal to cause display to render the corresponding response. For example, display 109 may be a video display with an interactive video object that performs movements in response to music or sound in accordance with a pre-specified command set, which might include commands like “jump” corresponding to a pre-specified audio criterion.

Alternatively, audio signal 104 may be received by audio data interface 303 which converts audio data signal to a MIDI format audio data signal 304. Audio data signal 304 is output and received as input by data converter 305 which parses the audio data signal 304 to assess the pitch and dynamic quality of the musical sound played.

Control logic in the data converter 305 determines whether the pitch and dynamic quality encoded in the audio data signal 304 meet the criteria for issuing a video or audio command and, if so, a validated data signal 108 encoded with the appropriate command (e.g., “jump”, “punch” or “kick”) is output.

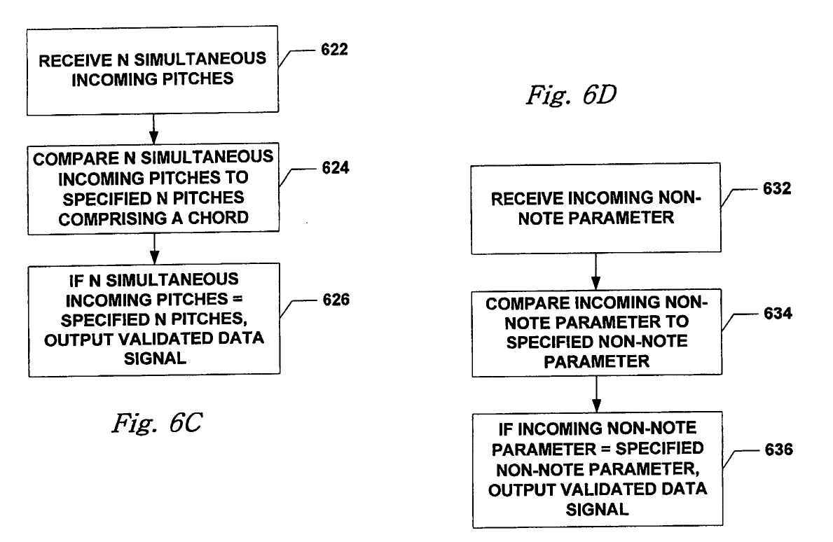

The system may be implemented as a stand-alone system, or in a kit adapted to connect to and communicate with a variety of displays. Also, the system may be implemented to work with commercially available video game consoles, and may even control other video games with music or sound. For example, in an alternative embodiment and with reference to FIG. 5, control command relay may be a plurality of control command relays 505 that are configured with control logic to output control command signals 404 to video/audio interface 405. The number of control relays may correspond to the number of video game objects to be controlled, and to the number of instruments that control them. The video/audio interface 405 accepts commands signals 404 as input from a corresponding command relays 505 and cause the execution of the proper actions according to the command signals 404. In this embodiment, video/audio interface 405 may be a commercially available video game console. Command signals 404 are in a format that would be acceptable control signals as input to the video game console.

In addition to the above mentioned uses, it will be apparent to those skilled in the relevant arts with the benefit of reading this disclosure that this system also enables the control of a variety of computer-based, software- or firmware-driven applications that are non-organic to the musical sound translating system. In other words, embodiments of the system do not need specifically adapted video display software. Devices embodying the foregoing features may be used with any pre-existing, or non-organic software application, whether it is a video game, or a non-game software application. Video games that may be controlled using the teachings herein include but are not limited downloaded or drive loaded software games, or games enabled by a video game emulator.

For example, embodiments of the system may be combined with a personal computer to provide control of such functions as accessing, composing, and sending email with musical sounds. As suggested above, this could be implemented in a stand-alone device configured with hardware and software to execute the functions disclosed herein as well as communications interface between the device and the personal computer, whether physically coupled via a Universal Serial Bus (USB) port, or other communications ports, or wirelessly through infrared, Bluetooth®, WiFi, or the like. Embodiments could implemented with the device incorporated in the personal computer as well, where the personal computer is configured with ports to receive MIDI coded signals and audio signals as described above. Further the personal computer may be configured with a built-in microphone to convert sound into an audio signal.

As described above, signal-to-data converter 103 is configured with control logic to parse the audio signal 104 or the MIDI coded signal 106 (collectively, the “sound input signal”) to determine the pitch, dynamic, or the sequence of pitches carried in the sound input signal 104, 106. Signal-to-data converter 103 may also be configured to parse two or more pitches played substantially simultaneously, e.g., a chord. Additionally, other parameters of the incoming sound input signal 104, 106 may be read including without limitation pitch effects, for example, bending. As described above, if the parameters encoded in the incoming sound input signal 104, 106 match the pre-determined criteria set in the signal-to-data converter 103 control logic, the validated data signal 108 corresponding to a video object action is output. Thus, the accuracy of such parameters rendered by the user is measured.

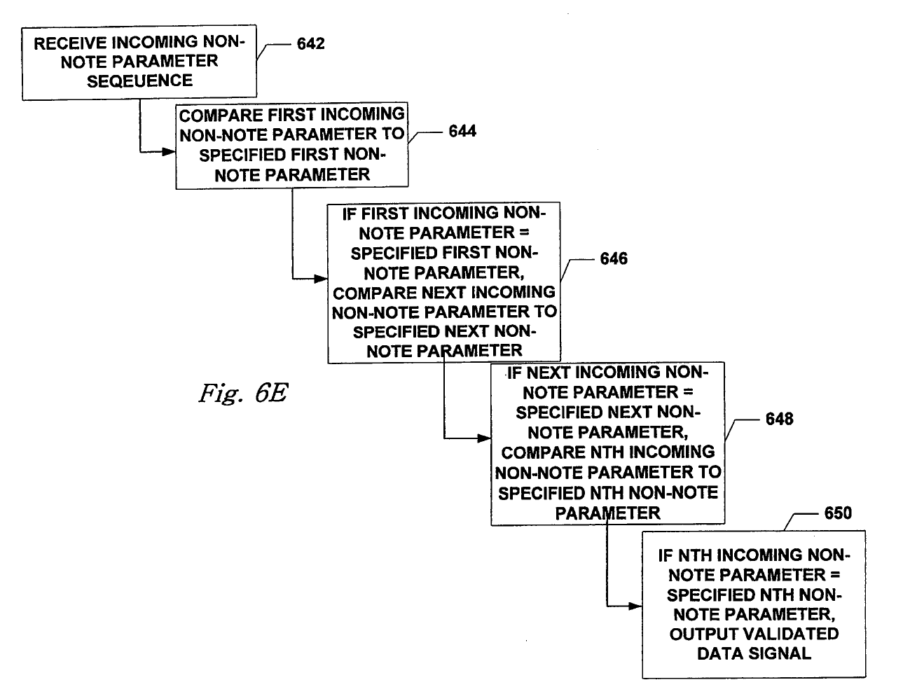

FIG. 6A is a flow chart of an exemplary method executed in the signal-to-data converter 103 for determining the accuracy of a single pitch from the musical instrument rendered at a given dynamic. The pitch and dynamic information is received 602 from the sound input signal 104, 106. It should be noted that the term “receive” includes parsing the pitch and dynamic information to determine the parameters' values. Pitch and dynamic information received is compared with pre-specified pitch and dynamic values 604, 606. It should be further noted that steps 604 and 606 could be performed in any order, or substantially simultaneously. If the received pitch and dynamic values match the pre-specified pitch and dynamic values, a validated data signal 108 corresponding to a video character command is output 608. Those skilled in the relevant arts will appreciate that this method may be used for just one parameter, e.g., pitch, alone, as well.

Similarly, FIG. 6B is a flow chart of another exemplary method executed in the signal-to-data converter 103 for determining the accuracy of pitch sequence of length n pitches. The pitch sequence is received 612 and the first incoming pitch is compared to the pre-specified first pitch for the sequence 614. If the first incoming pitch matches the pre-specified first pitch, the second incoming pitch is compared to the pre-specified second pitch 616. If the second incoming pitch matches the second pre-specified pitch, the next incoming pitch in compared to the pre-specified next pitch, and so on, until the nth incoming pitch is compared to the pre-specified nth pitch 618. If the nth incoming pitch matches the specified nth pitch, then the corresponding validated data signal 108 is output 620.

FIG. 6C is a flow chart of still another exemplary method executed in the signal-to-data converter 103, this one for determining the accuracy of a chord consisting of n simultaneously rendered pitches. A plurality of n pitches is received simultaneously 622 and the n simultaneous incoming pitches are compared to specified n pitches that make up a chord 624. If the n simultaneous incoming pitches matches the specified n pitches, a validated data signal 108 is output 626.

Yet another exemplary method executed by the data converter 203 is illustrated in the flow chart shown in FIG. 6D, for determining the accuracy of a signal not carrying pitch or dynamic information. Those skilled in the relevant arts will appreciate that MIDI formats include codes that are not indicative of pitch or dynamic but of other parameters, for example, without limitation, pitch bending, noise, timbre, amplitude, or sustain. Such messages are referred to as “non-note” parameters. Non-coded signals such as audio signal 104 may also include non-note parameters. In FIG. 6D, an incoming non-note parameter is received 632 and compared with a pre-specified non-note parameter 634. If the incoming non-note parameter matches the pre-specified non-note parameter, a validated data signal is output 636.

A final example of a method executed by the signal-to-data converter 103 is shown with reference to the flow chart of FIG. 6E. A method for determining the accuracy of a sequence of n non-note parameters, where a sequence of n such parameters is received 642. The first incoming non-note parameter is compared with a specified first non-note parameter 644. If the first incoming non-note parameter matches the specified first non-note parameter, the next incoming non-note parameter is compared to the specified next non-note parameter 646, and so on, until the nth incoming non-note parameter is compared to the specified nth non-note parameter 648. If the nth incoming non-note parameter matches the specified nth non-note parameter, a validated data signal is output 650.

In all of the foregoing descriptions related to FIGS. 6A through 6E, the terms “specified parameter” or “specified code” should be taken to mean the pre-specified parameter or code (or sequence of parameters or codes) corresponding to a particular display response. For example, a pre-specified parameters for a response of a video object jumping may correspond to an F7 chord. Thus, when the musician plays the F7 chord, the signal-to-data converter 103 receives MIDI codes 106 or audio signal 104 simultaneously indicating an F7 chord and compares it to the pre-specified parameters for F7. In another embodiment, the pre-specified parameters are included in a set of pre-specified parameters that, upon receipt of the incoming parameter signal, is searched, where the search looks for the pre-specified parameter matching the incoming parameter. If the matching parameter is found, a validated data signal is output. It should also be understood that although some of the foregoing methods discussed in terms of MIDI-formatted signals and MIDI codes, they have equal applicability where audio signals are not converted to MIDI-formatted signals.

Each of the components of the system described and shown may be implemented using a processor in a system configured with appropriate control logic. A processor, in effect, is a computer system. A computer system may include, for example, one or more processors that may be connected to a communication bus. The computer system can also include a main memory, preferably a random access memory (RAM), and can also include a secondary memory. The secondary memory can include, for example, a hard disk drive and/or a removable storage drive. The removable storage drive reads from and/or writes to a removable storage unit in a well-known manner. The removable storage unit, represents a floppy disk, magnetic tape, optical disk, and the like, which is read by and written to by the removable storage drive. The removable storage unit includes a computer readable storage medium having stored therein computer software (control logic) and/or data. The processor can be implemented by field programmable gated arrays (FPGA), application specific integrated circuits (ASIC), a micro-controller, a central processing unit (CPU) with a memory, or other logic device.

The secondary memory can include other similar means for allowing control logic or other instructions to be loaded into the computer system. Such means can include, for example, a removable storage unit and an interface. Examples of such can include a program cartridge and cartridge interface (such as that found in video game devices), a removable memory chip (such as an EPROM, or PROM) and associated socket, and other removable storage units and interfaces which allow software and data to be transferred from the removable storage unit to the computer system.

The computer system may execute an appropriate operating system such as Linux, Unix, Microsoft® Windows® 95, Microsoft® Windows® 98, Microsoft® Windows® NT, Apple® MacOS®, IBM® OS/2®, and the like. The computer may also be equipped with a network communication device such as a network interface card, a modem, or other network connection device suitable for connecting to one or more networks.

The term “control logic,” refers to computer programs are stored in the main memory and/or secondary memory. Such computer programs, when executed, enable the computer system to perform certain features of the embodiments described above.

The components of the system may be separable hardware units, or may be integrated into a single apparatus using a combination of hardware and software. Where separated units are implemented, data transfer may be accomplished over lines physically connecting two or more components. In the alternative, communication may be implemented wirelessly with any suitable wireless data transfer protocol, for example, without limitation, Bluetooth, IEEE 802 standard, or the like. Accordingly, it will also be appreciated that data transfer may be achieved over a personal area network (PAN), a local area network (LAN), a wide area network (WAN), or the World Wide Web.

Alternatively, it will be apparent that the components described in detail above may be implemented using one or more processors executing control logic stored on computer-readable medium where the control logic is adapted to perform the functions described above. It will also be apparent to those skilled in the art that the system may be embodied in devices that are adapted to provide control input to computer systems executing software applications that may use graphic user interfaces, for example, word processing or data processing applications. In this embodiment, a processor may execute instructions performing the functions described above, and such processor may also be configured to execute the instructions embodied in the controlled application.

While particular embodiments have been described in detail, it will be understood, however, that the invention claimed below is not limited thereto, since modifications may be made by those skilled in the art, particularly in light of the foregoing teachings. It is, therefore, contemplated by the appended claims to cover any such modifications that incorporate those features or those improvements, and any and all equivalents thereof, that embody the spirit and scope of the present invention.

I Claim:

1. A system for manipulating a video display using at least one musical tone as control input comprising:
a data converter for receiving a sound signal, said sound signal including one or more musical parameters associated with said musical tones, comparing said one or more received parameters to one or more pre-specified parameters, and converting said sound signal into a data signal based upon said parameters;
a control command relay for converting said data signal into a command signal; and
a display interface for converting said command signal to a display command signal.

2. The system of claim 1, wherein said sound signal is a MIDI signal.

3. The system of claim 2, wherein said musical parameters are at least one of pitch, dynamic, and rhythm.

4. The system of claim 1, further comprising an audio interface configured to receive said sound signal that is an audio signal and to convert said received audio signal into said MIDI signal.

5. The system of claim 1, wherein said at least one musical tone is one of a sequence of tones, and a set of generally simultaneously played tones.

6. The system of claim 5, wherein said sound signal is a MIDI signal.

7. The system of claim 6, wherein said musical parameters are at least one of pitch, dynamic, and rhythm.

8. The system of claim 5, further comprising an audio interface configured to receive said sound signal that is an audio signal and to convert said received audio signal into said MIDI signal.

9. The system of claim 8, wherein said musical parameters are at least one of pitch, dynamic, and rhythm.

10. A computer-readable medium having computer readable instructions stored thereon for execution by a processor to perform a method for manipulating an audio/video display using at least one musical tone as a control input, said method comprising the steps of:
comparing one or more received musical parameters to one or more pre-specified parameters, said one or more parameters associated with said at least one musical tone; and
converting said musical parameters into a display command signal.

11. The computer-readable medium of claim 10, wherein said step of converting further comprises the steps of:
converting a sound signal into a validated data signal; and
converting said validated data signal into said display command signal.

12. The computer-readable medium of claim 11, wherein said sound signal is a MIDI coded signal.

13. The computer-readable medium of claim 12, wherein said one or more parameters are at least one of pitch, dynamic, and rhythm.

14. The computer-readable medium of claim 13, wherein said method further comprises the steps of:
receiving an audio signal wherein said audio signal comprises said one or more musical parameters; and
converting said received audio signal into said MIDI signal.

15. The computer-readable medium of claim 10, wherein said at least one musical tone is one of
a sequence of tones, and
a set of generally simultaneously played tones.

16. The computer-readable medium of claim 15, wherein said coded signal is a MIDI signal.

17. The computer-readable medium of claim 16, wherein said one or more parameters are at least one of pitch, dynamic, and rhythm.

18. The computer-readable medium of claim 17, wherein said method further comprises the steps of:
receiving an audio signal; and
converting said received audio signal into said MIDI signal.

19. An apparatus for providing control input to a pre-existing software application, said software application configured to at least manipulate an audio/video display, said control input including at least one musical tone, comprising:
a data converter for receiving a musical parameter signal, said musical parameter signal including one or more parameters associated with said at least one musical tone, comparing said one or more received parameters to one or more stored parameters, said one or more stored parameters corresponding to a command signal recognizable by said pre-existing software application, and issuing a validated data signal based upon said parameters; and
a control command relay for converting said validated data signal into said command signal.

20. The apparatus of claim 19, wherein said musical parameter signal is a MIDI signal.

21. The apparatus of claim 19, wherein said musical parameters are at least one of pitch, dynamic, and rhythm, and wherein said at least one musical tone is one of a sequence of tones, and a set of generally simultaneously played tones.

22. The apparatus of claim 21, wherein said musical parameter signal is a MIDI signal.

23. The apparatus of claim 21, further comprising a transducer for converting sound energy into said musical parameter signal.
